(19) United States
(12) Patent Application Publication
(10) Pub. No.: US 2018/0190992 A1
(43) Pub. Date: Jul. 5, 2018

(54) ELECTROCHEMICAL ACCUMULATOR, WITH PLANAR ARCHITECTURE OBTAINED IN PART BY PRINTING

(71) Applicant: Commissariat A L'Energie Atomique et aux Energies Alternatives, Paris (FR)

(72) Inventors: David PERALTA, Grenoble (FR); Sebastien Solan, Seyssinet-Pariset (FR)

(73) Assignee: Commissariat A L'Energie Atomique et aux Energies Alternatives, Paris (FR)

(21) Appl. No.: 15/860,855

(22) Filed: Jan. 3, 2018

(30) Foreign Application Priority Data
Jan. 5, 2017 (FR) 17 50102

(51) Int. Cl. H01M 4/66; H01M 10/39; H01M 8/0241; H01M 8/0232; H01M 4/131; H01M 4/505

(52) U.S. Cl. CPC H01M 4/667; H01M 10/3981; H01M 8/0241; H01M 4/663; H01M 4/131; H01M 4/661; H01M 4/505; H01M 8/0232

(57) ABSTRACT

A metal-ion accumulator, including a metal element of flat surface forming a current collector of an electrode of one polarity; an insulating layer, deposited on the metal element while defining an interlocking pattern; a layer forming a current collector of an electrode of opposite polarity to the one having the current collector formed by the metal element, the collector layer being deposited on the interlocking pattern of the insulating layer; an electrode layer, deposited on the metal element according to a pattern at least partly interlocked in the interlocking pattern; an electrode layer of opposite polarity to the one deposited on the metal element, the layer of opposite polarity being deposited on the collector layer according to the interlocking pattern; a layer of electrolyte deposited at least in the spaces between the two layers of active materials of opposite polarity.

### TECHNICAL FIELD

The present invention relates to the field of metal-ion electrochemical generators, which operate according to the principle of insertion or deinsertion, or in other words intercalation-deintercalation, of metal ions in at least one electrode.

It relates more particularly to a lithium or lithium-ion electrochemical accumulator.

The invention relates to the creation of a novel architecture of metal-ion electrochemical accumulator that makes it possible to miniaturize it, in order to make it flexible and/or to be able to integrate it directly into objects, in particular electronic devices.

Although described with reference to a lithium-ion accumulator, the invention applies to any metal-ion electrochemical accumulator, i.e. also to sodium-ion accumulators, magnesium-ion accumulators, aluminum-ion accumulators, etc.

### PRIOR ART

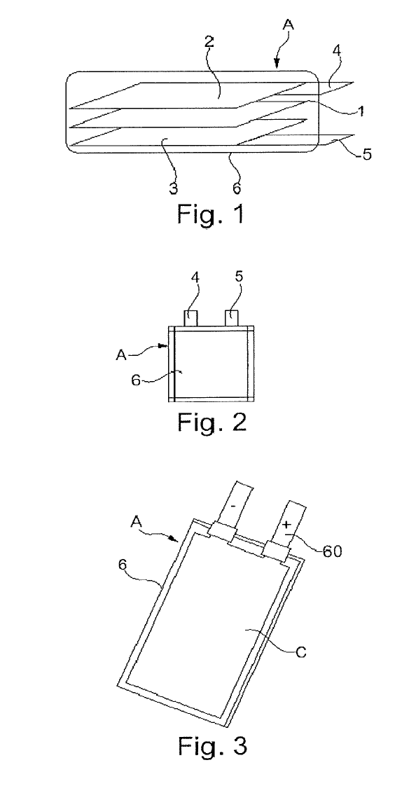

As illustrated schematically in FIGS. 1 and 2, a lithium-ion battery or accumulator usually comprises at least one electrochemical cell C consisting of an electrolyte constituent 1, impregnated in a separator that makes it possible to electrically isolate the electrodes, between a positive electrode or cathode 2 and a negative electrode or anode 3, a current collector 4 connected to the cathode 2, a current collector 5 connected to the anode 3 and, finally, a package 6 arranged to contain the electrochemical cell in a manner that is impermeable to water, oxygen and nitrogen, while being passed through by a portion of the current collectors 4, 5.

The architecture of conventional lithium-ion batteries is an architecture that may be described as monopolar, since it has a single electrochemical cell comprising an anode, a cathode and an electrolyte. Several types of monopolar architecture geometry are known:
a cylindrical geometry, with winding around a cylindrical axis as disclosed in patent application US 2006/0121348;
a prismatic geometry, with winding around a parallelepipedal axis as disclosed in U.S. Pat. No. 7,348,098 and U.S. Pat. No. 7,338,733;
a stacked geometry as disclosed in patent applications US 2008/060189 and US 2008/0057392 and U.S. Pat. No. 7,335,448.

The electrolyte constituent 1 may be of solid, liquid or gel form. In the latter form, the constituent may comprise a separator made of polymer, of ceramic or of microporous composite saturated with organic electrolyte(s) or ionic liquid electrolyte(s) that allow the lithium ion to move from the cathode to the anode during the charging process and vice versa during the discharging process, which in the latter case generates the current, by movement of electrons in the external circuit. The electrolyte is in general a mixture of organic solvents, for example carbonates, to which a lithium salt, typically LiPF₆, is added.

The positive electrode or cathode 2 consists of lithium cation insertion materials which are in general composite, such as lithiated iron phosphate LiFePO₄, lithiated cobalt oxide LiCoO₂, optionally substituted lithiated manganese oxide LiMn₂O₄ or a material based on LiNixMnyCozO₂ with x+y+z=1, such as LiNi_{0.33}Mn_{0.33}Co_{0.33}O₂, or a material based on LiNixCoyAlzO₂ with x+y+z=1, LiMn₂O₄, LiNiMnCoO₂ or lithiated nickel cobalt aluminum oxide LiNiCoAlO₂.

The negative electrode or anode 3 very often consists of graphite carbon or is made of Li₄Ti₅O₁₂ (titanate material), optionally also based on silicon or on a silicon-based composite.

A negative electrode of a lithium-ion accumulator may be formed from a single alloy or from a mixture of alloys, or from a mixture of alloy(s) and other lithium insertion material(s) (graphite, in synthetic or natural form, Li₄Ti₅O₁₂, TiO₂, etc.), optionally also based on silicon or based on lithium, or based on tin and alloys thereof or on a silicon-based composite. This negative electrode, just like the positive electrode, may also contain electron-conducting additives and also polymer additives that give it mechanical properties and an electrochemical performance that are appropriate for the lithium-ion battery application or for the implementation process thereof.

The current collector 4 connected to the positive electrode is in general made of aluminum.

The current collector 5 connected to the negative electrode is in general made of copper, of nickel-plated copper or of aluminum.

The anode and the cathode made of lithium insertion material may be deposited continuously according to a standard technique in the form of an active layer on a metal sheet or foil forming a current collector.

A lithium-ion battery or accumulator may of course comprise a plurality of electrochemical cells which are stacked on one another.

Conventionally, an Li-ion battery or accumulator uses a pair of materials at the anode and at the cathode that enable it to operate at a high voltage level, typically between 1.5 and 4.2 volts.

Depending on the type of application targeted, it is sought to produce either a rigid accumulator or a thin and flexible accumulator: the package is then respectively either rigid and forms a casing so to speak, or flexible.

Flexible packages are usually made from a multilayer composite material consisting of a stack of aluminum layers covered by one or more polymer film(s) laminated by adhesive bonding. In most of these flexible packages, the polymer covering the aluminum is chosen from polyethylene (PE), propylene and polyamide (PA) or may be in the form of an adhesive layer consisting of polyester-polyurethane. The company Showa Denko sells composite materials of this type for use as battery packages under the references NADR-0N25/AL40/CPP40 or No. ADR-0N25/AL40/CPP80.

In patent application FR 2955974 the Applicant also proposed an improved flexible package based on one or more sheets of polyaryletherketone (PAEK).

A flexible accumulator, commonly referred to as a thin-film battery, usually consists of a single electrochemical cell.

FIG. 3 illustrates this type of flexible package 6 which is arranged to contain the electrochemical cell C in an impermeable manner while being passed through by a portion 40, 50 of two strips 4, 5 forming the poles and which extend in the plane of the electrochemical cell. As shown in FIG. 3, polyolefin-based polymer reinforcements 60 may be provided to improve the heat sealing of the package 6 around the strips 4, 5. The main advantage of flexible packages is their lightness. Li-ion accumulators with the greatest energy densities therefore have a flexible package. The major drawback of these flexible packages is that their impermeability may deteriorate greatly over time due to the lack of chemical resistance of the sealing produced.

Rigid packages are themselves used when the targeted applications are constraining, where a long service life is desired, with for example much higher pressures to be withstood and a stricter degree of impermeability required, typically of less than 10⁻⁸ mbar.l/s, or in environments with high stresses such as the aeronautical or spatial field. The constituent material of an Li-ion accumulator casing is usually metallic, typically an aluminum alloy, or made of stainless steel or made of rigid polymer such as for example acrylonitrile-butadiene-styrene (ABS).

The main advantage of rigid packages is thus their high impermeability which is maintained over time due to the fact that the casings are sealed by welding, in general by laser welding.

In order to make the electronic elements more integratable, it is advisable to reduce their dimensions as much as possible.

For several years, batteries or accumulators have been following this trend.

In addition to the research into miniaturizing accumulators or batteries, there is new research in order to make them flexible or else to integrate them directly into objects.

To meet these demands, various battery architectures are studied. The two best-known architectures are planar architecture and the other is architecture with an interdigitated pattern.

In the literature, there are thus several patent applications/patents that protect novel accumulator/battery architecture solutions.

The Applicant thus proposed in patent application FR 3007207 an accumulator architecture with an interdigitated pattern produced by a printing technique on an electronically insulating substrate.

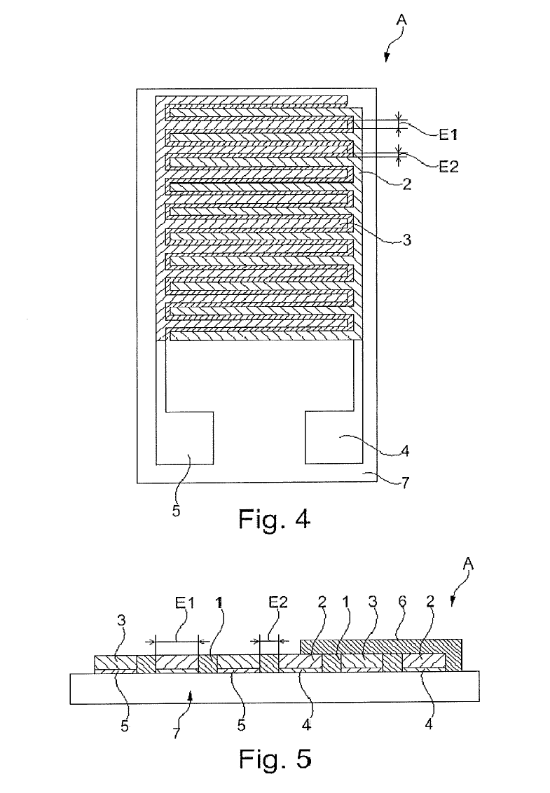

Illustrated in FIGS. 4 and 5 is an exemplary embodiment of an accumulator A according to the teaching of that patent application. That accumulator A comprises an electronically insulating substrate 7, deposited on which is a first current collector 4, the pattern of which comprises a plurality of parallel bands connected by a main band and that is partially covered by a layer of insertion active material 2. The first collector 4 coated with the layer 2 forms a positive electrode.

A second current collector 5 is deposited on the substrate 7 according to a complementary pattern that is interlocked in the pattern of the first current collector 4. Thus, the first and second current collectors 4, 5 form an interdigitated pattern.

The second collector 5 is partially covered with a layer of insertion active material 3 and thus forms a negative electrode.

The ends of the collectors 4, 5 not covered by the layers of active material define the ends for electrical connection to the outside of the accumulator. The positive electrodes 2, 4 and negative electrodes 3, 5 may have the same width. The width E1 of the positive electrodes 2, 4 and negative electrodes 3, 5 is between 10 and 200 micrometers.

A layer of electrolyte 1 is deposited in the spaces between a positive electrode 2, 4 and a negative electrode 3, 5. The inter-electrode distance E2, or inter-band distance, defined by the interdigitated pattern and which is filled by the electrolyte 1 is between 1 and 50 micrometers.

All of the components of that accumulator are produced by a high-definition printing technique on the electronically insulating substrate 7. This may be an aerosol jet printing (AJP) or a screen printing or else a drop-on-demand (DOD) inkjet printing or else a continuous inkjet (CIJ) printing. In all these printing techniques, the materials in the form of an ink formed of nanoparticles are propelled or deposited onto the support before undergoing a sintering.

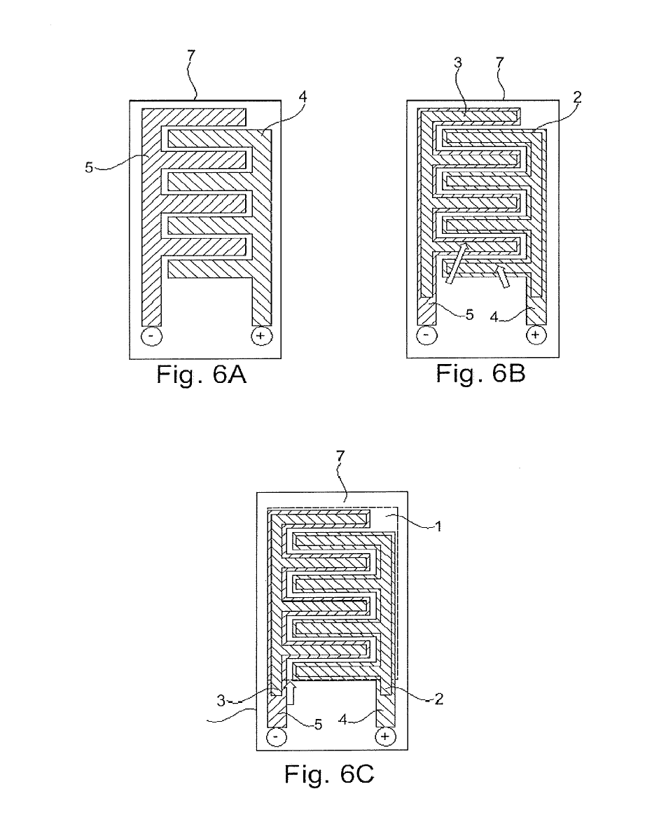

The various steps of producing such an accumulator A have been illustrated schematically in FIGS. 6A to 6C.

The layers forming the positive 4 and negative 5 current collectors are firstly deposited by printing on the electronically insulating substrate 7, forming the interdigitated pattern (FIG. 6A).

Next, the layers of respectively positive 2 and negative 3 insertion active material are each printed onto their collector 4, 5, partially covering them (FIG. 6B).

Lastly, a layer of electrolyte 1 is printed which fills all the spaces between the positive electrode 2, 4 and negative electrode 3, 5 with the exception of the ends of the collectors 4, 5 that form the electrical connection ends (FIG. 6C).

Compared to an accumulator produced customarily by stacking or winding as described in connection with FIGS. 1 to 3, an accumulator of the type of that according to the aforementioned application FR 3007207 has many advantages, among which mention may be made of:
the lack of constraints regarding the densification of the insertion active materials since it is possible to carry out a simultaneous calendering of the two layers of active material unlike the layers coated on the metal foils;
the lack of constraints regarding the penetration of the electrolyte since there is no activation of the accumulator by a liquid electrolyte, which is usually carried out for a stacked accumulator, or wound accumulator, this liquid electrolyte activation step possibly proving to be relatively slow;
the possibility of using a wide range of formulations (solvents) and of materials (active materials or electrolytes). Specifically, in stacked or wound accumulators, it is only possible to print an organic phase separator on an aqueous phase electrode then only an aqueous phase electrode on the separator to avoid dissolving the constituent polymer of the separator, which limits the formulations of active materials that are accessible;
the adjustment of the grammage may be carried out over the width and over the height of the electrodes;
the current collectors printed on one and the same plane facilitate the electrical interconnection with the systems to be powered;
a thinner and therefore more flexible final battery;
the lack of limitation regarding the size of the patterns.

The current research on the type of accumulators with interdigitated pattern as described in the aforementioned application FR 3007207 tends to create accumulators with ever increasingly high energy densities.

For this, it is advisable to use cathode materials having very high specific energies such as lamellar oxides of formula Li₁₊ₓNiₐMn_{b}Co_{c}M_{d}O₂ or else materials of spinel type or others.

In order to draw the maximum energy from these materials, it is advisable to make them undergo cyclings at high potentials. By way of example, the standard lamellar oxides most used in the field of high-energy batteries have the formula LiNi_{1/3}Mn_{1/3}Co_{1/3}O₂ and are used under voltage limits ranging from 4.3 V to 2.7 V.

The materials referred to as super-lithiated lamellar oxides (Li_{1+X}NiₐMn_{b}Co_{c}O₂) or else the spinels referred to as 5V spinels (LixM_{0.5}Mn_{1.5}O₄) are considered to be the next generations of high energy density materials and these materials cycle respectively under potential limits between 4.8 V and 2.5 V and between 5 V and 3.5 V.

For high-energy accumulators, conventionally produced by stacking or winding, the current collectors pose no problem since the anode and the cathode may be coated directly by printing on metal foils, made of aluminum or made of copper depending on the potential limits targeted.

When the accumulators are miniaturized, the current collector may then pose a problem. In the case of an architecture having an interdigitated pattern, like that of the aforementioned application FR 3007207, the current collectors are obtained by printing, preferably by inkjet printing as mentioned above.

Currently, these printed collectors are obtained using carbon, gold or else copper nanoparticle inks.

For applications where the cycling of the materials may be relatively slow, the use of carbon nanoparticles may suffice. But when the cycling regimes increase, this type of collector may become much less efficient than a current collector in the form of a metal foil in stacked or wound architectures. Gold of course poses the problem of its intrinsic cost. Copper may be envisaged as a very good option for materials where the cycling may be carried out in a potential range that does not exceed 3 V.

Nevertheless, the positive insertion active materials, i.e. those forming the cathodes, which have the highest energy densities, require a cycling at potentials generally greater than 3 V. This is particularly prejudicial since copper is not stable at a potential of greater than 3 V.

Consequently, in the batteries produced customarily by stacking or winding as described in connection with FIGS. 1 to 3, the cathode active materials are generally deposited on an aluminum foil. This is because aluminum exhibits no stability problems for potentials of greater than 3 V.

However, to date, it is not possible to print current collectors made of aluminum. This is because aluminum nanoparticles are not commercially available and, even if they became available, the temperatures necessary for sintering these particles would render their use difficult for printing onto electronically insulating substrates, in particular polymer substrates.

There is therefore a need to improve the lithium, and more generally metal-ion, accumulators produced at least in part by printing on an electronically insulating substrate especially in order to increase their energy density, without this being carried out to the detriment of their compactness.

The general objective of the invention is to at least partly meet this need.

### SUMMARY OF THE INVENTION

In order to do this, one subject of the invention is a metal-ion electrochemical accumulator, comprising:
a metal element forming a current collector of an electrode of one polarity;
a layer of electrically insulating material, deposited on the metal element, defining an interlocking pattern;
a layer forming a current collector of an electrode of opposite polarity to the one having the current collector formed by the metal element, the collector layer being deposited on the interlocking pattern of the insulating layer;
a layer of electrode active material, deposited on the metal element according to a pattern at least partly interlocked in the interlocking pattern;
a layer of electrode active material of opposite polarity to the one deposited on the metal element, the layer of opposite polarity being deposited on the collector layer according to the interlocking pattern;
a layer of electrolyte deposited at least in the spaces between the two layers of active materials of mutually opposite polarity.

An “interlocking pattern” is understood here and within the context of the invention to mean a geometric surface of the insulating layer inside which at least one portion of a geometric surface of another layer may be inserted. An interdigitating pattern is a particularly advantageous pattern like the interlocking pattern according to the invention.

According to a first embodiment, the metal element is a metal substrate formed by at least one part of an object to be electrically powered by the accumulator. This embodiment has the advantage of being able to directly integrate the accumulator according to the invention into a part of the object. For example, if the object is a cell phone, where the shell of the casing is metallic, this shell may be used as the metal element of the accumulator.

According to a second embodiment, the accumulator additionally comprises a substrate made of electronically insulating material, the metal element being a metal foil applied against the substrate.

The electronically insulating substrate may advantageously be a polymer substrate chosen from polyethylene terephthalate (PET), polyethylene (PE), polypropylene (PP), polyamide (PA), polyimide (PI), polyether ether ketone (PEEK) or a metal substrate covered with an electronically insulating layer or a substrate made of an electric insulating oxide.

The foil applied against the substrate is preferably an aluminum foil.

Thus, according to the invention, an accumulator architecture is produced that is essentially obtained by deposition of layers, preferably by printing, with the exception of one of the current collectors formed by a metal element, such as a foil which is bound to the electronically insulating substrate by applying against it, preferably by a stamping technique.

The metal element according to the invention serves both as current collector for one of the electrodes and support for all the other functional layers of the electrochemical core of the accumulator.

Owing to the invention, it is possible to produce a current collector made of aluminum or any other metal that is stable under the potential conditions, for one of the terminals, in particular the positive terminal of an Li-ion accumulator. It is thus possible to increase the energy density of the accumulators with interdigitated architecture since the use of an element made of aluminum or other stable metal makes it possible to coat this element with insertion active materials having very high specific energies and that may undergo cycles at potentials of greater than 3 V.

In other words, all the advantages of an accumulator with interdigitated architecture are retained, as described in application FR3007207 A1 with in addition the possibility of considerably increasing the energy density, and this without adversely affecting the bulkiness of the accumulator.

Another advantage linked to the invention is the possibility of a direct use of the metal surface of an object as support and current collector for the creation of the accumulator according to the invention.

With the exception of the metal foil applied against the substrate, all the other layers (current collector of opposite polarity to that of the foil, insertion active materials, electrolyte layer) are preferably deposited by a printing technique, more preferably by screen printing on the current collector substrates.

Other printing techniques may be used such as flexographic printing, rotogravure printing, spray coating, inkjet printing, aerosol jet printing, etc. An important advantage of the printing techniques is being able to manufacture patterns of varied (square, rectangular, round or more complex) cross section and therefore makes it possible to acquire a certain freedom regarding the design of the accumulator according to the invention. Screen printing may be favored since it has the advantage of being able to deposit a larger amount of ink in a single pass, which makes it possible to obtain high grammages and therefore high capacities. Similarly, the production rates are high, compared to coating which is the conventional process used by battery manufacturers, typically a printing speed of 20 to 25 m/s for screen printing compared with a speed of 10 to 15 m/s for coating.

The connections or poles that emerge from the package of the accumulator, for connecting the accumulator to an external circuit, are formed of bands of the current collectors by themselves, preferably made of aluminum for the positive electrode and made of copper or carbon for the negative electrode.

According to one advantageous variant, the interlocking and interlocked patterns form an interdigitated pattern or a spirally wound pattern.

The material of the electrically insulating layer is advantageously chosen from a polymer, a ceramic, an electrically insulating oxide, and an organic-inorganic composite material. The polymer may be chosen from polyvinylidene fluoride (PVDF), polymethyl methacrylate (PMMA), polyvinyl alcohol (PVA) and polyvinylpyrrolidone (PVP).

The insulating oxide may be alumina or silica (SiO₂).

According to one embodiment variant, the current collector formed by the metal element is the collector of positive polarity.

According to one advantageous embodiment, the accumulator according to the invention additionally comprises a package that encapsulates all of the elements of the accumulator while leaving free one end of the metal element and one end of the current collector layer, which are intended to provide the electrical connections to the outside of the accumulator.

One particularly advantageous accumulator according to the invention comprises:
a flexible polymer substrate;
an aluminum foil, stamped on the substrate;
a polymer layer defining the interlocking pattern;
a copper or carbon layer deposited on the polymer layer according to the interlocking pattern;
a layer of lithium insertion material of positive polarity, deposited on the aluminum foil according to the pattern at least partly interlocked in the interlocking pattern;
a layer of lithium insertion material of negative polarity, deposited on the copper or carbon layer according to the interlocking pattern;
a layer of electrolyte deposited at least in the spaces between layers of lithium insertion materials of positive and negative polarity.

The accumulator according to the invention may be an Li-ion accumulator, the electrode layers being made of lithium insertion material.

The expression “electrode made of lithium insertion material” is understood, here and in the context of the invention, to mean an electrode pattern comprising at least one lithium insertion material and at least one binder made of polymer. Optionally, the electrode pattern may in addition comprise an electronic conductor, for example carbon fibers or carbon black.

The expression “lithium insertion material” is, in particular for the positive electrode layer pattern, understood, here and in the context of the invention, to mean a material chosen from manganese-containing lithiated oxides of spinel structure, lithiated oxides of lamellar structure, and mixtures thereof, and polyanionic framework lithiated oxides of formula LiM_{y}(XO_{z})ₙ with M representing an element chosen from Mn, Fe, Co, Ni, Cu, Mg, Zn, V, Ca, Sr, Ba, Ti, Al, Si, B and Mo, X representing an element chosen from P, Si, Ge, S and As, and y, z and n being positive integers.

The expression “lithium insertion material” is also, in particular for the negative electrode layer pattern, understood to mean a material chosen from: a lithiated or non-lithiated titanium oxide, for example Li₄Ti₅O₁₂ or TiO₂. More particularly, the negative electrode pattern material may be chosen from carbon-containing materials, non-lithiated titanium oxides and their derivatives and lithiated titanium oxides, such as Li₄Ti₅O₁₂, and their derivatives, and a mixture thereof.

The expression “lithiated derivative” is understood, here and in the context of the invention, to mean compounds of formula Li₍₄₋ₓ₁₎Mₓ₁Ti₅O₁₂ and Li₄Ti_{(5-y1)}N_{y1}O₁₂, where x1 and y1 are respectively between 0 and 0.2 and M and N are respectively chemical elements chosen from Na, K, Mg, Nb, Al, Ni, Co, Zr, Cr, Mn, Fe, Cu, Zn, Si and Mo.

The expression “non-lithiated derivative” is understood, here and in the context of the invention, to mean Ti_{(5-y1)}N_{y1}O₁₂, with y1 between 0 and 0.2 and N is a chemical element chosen from Na, K, Mg, Nb, Al, Ni, Co, Zr, Cr, Mn, Fe, Cu, Zn, Si and Mo.

Preferably, the anodes are made of graphite and the cathodes of LiFePO₄.

Another subject of the invention is a process for producing a metal-ion accumulator, comprising the following steps:
a/ providing a metal element that forms a current collector of an electrode of one polarity;
b/ depositing, on the metal element, an electrically insulating layer according to an interlocking pattern;
c/ depositing, on the electrically insulating layer, a layer forming a current collector of an electrode of opposite polarity to the one having the current collector formed by the metal element, the current collector layer being deposited on the interlocking pattern of the electrically insulating layer;
d/ depositing, on the metal element, a layer of electrode active material according to a pattern at least partly interlocked in the interlocking pattern;
e/ depositing, on the current collector layer, a layer of electrode active material of opposite polarity to the one deposited on the metal element, according to the interlocking pattern;
f/ depositing an electrolyte layer at least in the spaces separating the two layers of active material of mutually opposite polarity.

Step a/ may be carried out advantageously by stamping a metal foil on an electronically insulating substrate.

Advantageously, the deposition steps b/ to f/ are carried out by a printing technique.

The advantages of the architecture of the accumulator according to the invention compared to the architectures according to the prior art are numerous, among which mention may be made of:
the possibility of considerably increasing the energy density of an accumulator, in particular an Li-ion accumulator, and this without adversely affecting the bulkiness thereof;
the possibility of a direct use of the metal surface of an object as support and current collector for the creation of the accumulator according to the invention.

The targeted applications for the accumulator according to the invention are numerous.

The invention thus relates more particularly to the use for electrically powering a portable electronic device, the accumulator being integrated into the casing of the device.

Another more general use of the accumulator is for electrically powering any electronic device with a location having shape and/or space constraints.

These may be RFID (radio frequency identification) sensors or antennae intended to be implanted or lodged in the passenger compartment of a motor vehicle, or in the slightest available recess of the vehicle, for information communication.

### DETAILED DESCRIPTION

Other features and advantages will become more clearly apparent on reading the detailed description, which is given by way of illustration and with reference to the following figures, in which:

FIG. 1 is a schematic exploded perspective view showing the various elements of a lithium-ion accumulator;

FIG. 2 is a photographic perspective view showing a lithium-ion accumulator with its flexible package according to the prior art;

FIG. 3 is a perspective view showing the outside of a lithium-ion accumulator with its flexible package according to the prior art, with the sealing bands necessary for sealing the flexible package and a welding band necessary for welding the current collectors;

FIG. 4 is a schematic front view of an Li-ion accumulator produced by printing according to patent application FR3007207 A1;

FIG. 5 is a cross-sectional view of FIG. 4;

FIGS. 6A to 6C are front views and illustrate the main steps of producing an accumulator according to FIGS. 4 and 5;

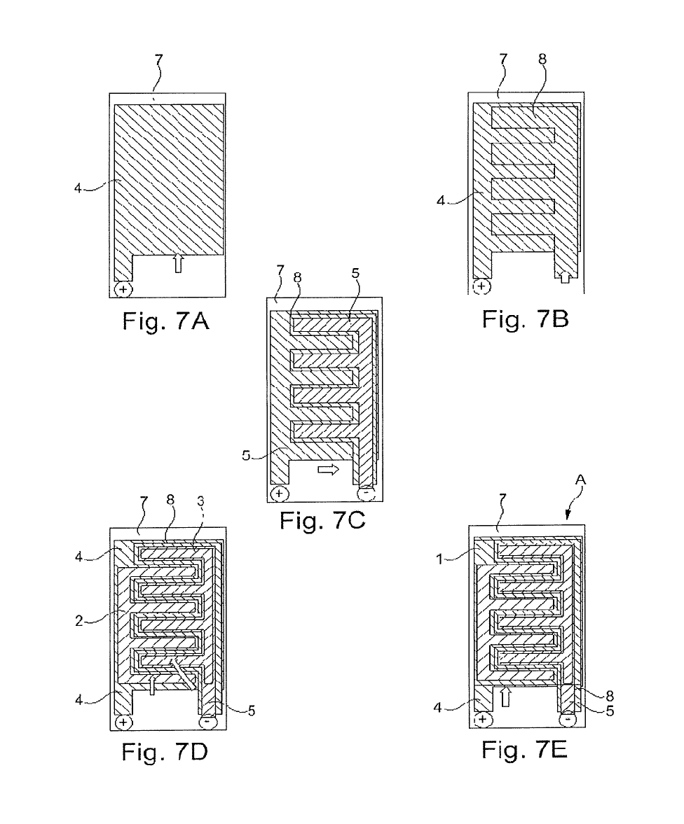

FIGS. 7A to 7E are front views and illustrate the main steps of producing an example of an accumulator according to the invention;

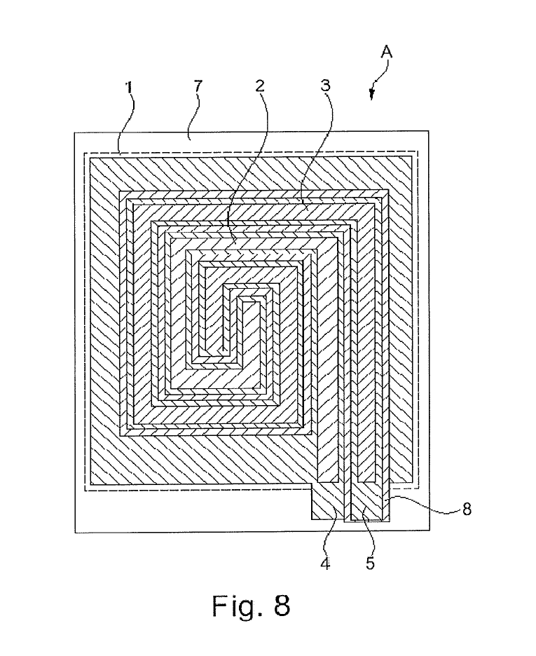

FIG. 8 is a schematic front view showing another example of an accumulator according to the invention.

For the sake of clarity, the same references denoting the same elements of an accumulator according to the prior art and of an accumulator according to the invention are used for all the FIGS. 1 to 8.

It is specified that the various elements according to the invention are represented solely for the sake of clarity and that they are not to scale. FIGS. 1 to 6C have already been commented on in the preamble. They will not therefore be described in detail below.

The invention is described below with reference to an exemplary embodiment of an Li-ion accumulator having an interdigitated pattern.

The various steps of producing such an accumulator are described with reference to FIGS. 7A to 7E.

Step a/: firstly an electronically insulating substrate 7 is put in place. It is advantageously a polymer substrate chosen from polyethylene terephthalate (PET), polyethylene (PE), polypropylene (PP), polyamide (PA), polyimide (PI) and polyether ether ketone (PEEK).

A metal foil 4 made of aluminum is stamped, by deposition if necessary with adhesive bonding, on the substrate 7, forming the cathode current collector (FIG. 7A). As illustrated, the stamped aluminum foil 4 has one end intended to form the positive electrical connection.

Step b/: an electrically insulating layer 8 is then printed on the aluminum foil 4 according to an interlocking pattern (FIG. 7B). As illustrated, this pattern is formed of a plurality of parallel bands connected by a main band. In other words, this interlocking pattern forms an interdigitating comb.

The insulating layer 8 is preferably made of polymer, more preferably chosen from polyvinylidene fluoride (PVDF), polymethyl methacrylate (PMMA), polyvinyl alcohol (PVA) and polyvinylpyrrolidone (PVP).

Step c/: a carbon or copper layer 5 is then printed on the electrically insulating layer 8, forming a negative current collector (FIG. 7C). As illustrated, the carbon or copper layer 5 is deposited on the interlocking pattern of the insulating layer 7.

Step d/: a layer of positive electrode active material 2 is then printed on the aluminum foil 4 according to a pattern at least partly interlocked in the interlocking pattern (FIG. 7D), that is to say according to a comb complementary to the interdigitating comb already produced with the insulating layer 7 and current collector layer 5. The aluminum foil 4 covered with the printed layer 2 then forms the cathode of the accumulator.

Step e/: a layer of negative electrode active material 3 is then printed, at the same time as or with a time lag relative to step d/, on the current collector layer 5 according to the interlocking pattern (FIG. 7D).

Thus, after the printing of the positive 2 and negative 3 active layers, the interdigitated pattern is formed, only one end respectively of the aluminum foil 4 stamped on the substrate 7 and of the copper or carbon layer 5 protruding in order to be able to produce the electrical interconnection with the outside of the accumulator A.

Step f/: a layer of electrolyte 1 is then printed at least in the spaces separating the two positive 2 and negative 3 layers (FIG. 7E). In the example illustrated, the layer of electrolyte 1 covers all of the components with the exception of the electrical connection ends.

All the functional layers of the accumulator can then be covered with a package, preferably by encapsulation using an electrically and thermally insulating material.

By producing the positive current collector 4 by stamping of an aluminum foil, the Li-ion accumulator retains all the advantages of an Li-ion accumulator as described in application FR3007207 A1 with, in addition, the possibility of an increased energy density, and this with a great compactness.

Illustrated in FIG. 8 is a rectangular spiral architecture of an Li-ion accumulator that it is possible to obtain by means of the invention.

Such an accumulator may advantageously be used directly as part of an object, in particular of an electronic device, the electric power supply of which is provided by the accumulator. For example, the geometry illustrated in FIG. 8 could be printed inside an aluminum casing shell of a cell phone, which would make it possible to considerably reduce the thickness of the phone.

In this configuration, it is also advantageously possible to do away with an insulating substrate 7 and with a metal foil 4 in its current form, the metal element forming the current collector advantageously being formed by the aluminum shell of the cell phone casing.

By way of exemplary embodiment, an accumulator according to the invention may be produced with an aluminum foil 4 coated with a printed layer 2, of positive active material on top, for example LiNi_{0.33}Mn_{0.33}Co_{0.33}O₂. Next to the positive layer 2 a layer of insulating polymer 8 is printed, defining the interlocking pattern. On this insulating layer 8, a copper layer 5 is printed according to the same pattern then, on this copper layer 5, a layer 3 of anode active material, for example made of Li₄Ti₅O₁₂, is printed.

Other variants and advantages of the invention may be produced without however departing from the scope of the invention.

The invention is not limited to the examples which have just been described; features of the examples illustrated may in particular be combined together in variants that have not been illustrated.

1. A metal-ion electrochemical accumulator, comprising:
a metal element of flat surface forming a current collector of an electrode of one polarity;
a layer of electrically insulating material, deposited on the metal element, defining an interlocking pattern;
a layer forming a current collector of an electrode of opposite polarity to the one having the current collector formed by the metal element, the collector layer being deposited on the interlocking pattern of the insulating layer;
a layer of electrode active material, deposited on the metal element according to a pattern at least partly interlocked in the interlocking pattern;
a layer of electrode active material of opposite polarity to the one deposited on the metal element, the layer of opposite polarity being deposited on the collector layer according to the interlocking pattern;
a layer of electrolyte deposited at least in the spaces between the two layers of active materials of mutually opposite polarity.

2. The accumulator according to claim 1, the metal element being a metal substrate formed by at least one part of an object to be electrically powered by the accumulator.

3. The accumulator according to claim 1, additionally comprising a substrate made of electronically insulating material, the metal element being a metal foil applied against the substrate.

4. The accumulator according to claim 3, the electronically insulating substrate being a polymer substrate chosen from polyethylene terephthalate (PET), polyethylene (PE), polypropylene (PP), polyamide (PA), polyimide (PI), polyether ether ketone (PEEK) or being a metal substrate covered with an electronically insulating layer or being a substrate made of an electrically insulating oxide.

5. The accumulator according to claim 3, the foil applied against the substrate being an aluminum foil.

6. The accumulator according to claim 1, the interlocking and interlocked patterns forming an interdigitated pattern or a spirally wound pattern.

7. The accumulator according to claim 1, the material of the electrically insulating layer being chosen from a polymer, a ceramic, an electrically insulating oxide, and an organic-inorganic composite material.

8. The accumulator according to claim 7, the polymer being chosen from polyvinylidene fluoride (PVDF), polymethyl methacrylate (PMMA), polyvinyl alcohol (PVA) and polyvinylpyrrolidone (PVP).

9. The accumulator according to claim 7, the insulating oxide being alumina or silica (SiO2).

10. The accumulator according to claim 1, the current collector formed by the metal element being the collector of positive polarity.

11. Accumulator The accumulator according to claim 1, additionally comprising a package that encapsulates all of the elements of the accumulator while leaving free one end of the metal element and one end of the current collector layer, which are intended to provide the electrical connections to the outside of the accumulator.

12. A li-ion accumulator according to claim 3, comprising:
a flexible polymer substrate;
an aluminum foil, stamped on the substrate;
a polymer layer defining the interlocking pattern;
a copper or carbon layer deposited on the polymer layer according to the interlocking pattern;
a layer of lithium insertion material of positive polarity, deposited on the aluminum foil according to the pattern at least partly interlocked in the interlocking pattern;
a layer of lithium insertion material of negative polarity, deposited on the copper or carbon layer according to the interlocking pattern;
a layer of electrolyte deposited at least in the spaces between layers of lithium insertion materials of positive and negative polarity.

13. A process for producing a metal-ion accumulator, comprising the following steps:
a/ providing a metal element that forms a current collector of an electrode of one polarity;
b/ depositing, on the metal element, an electrically insulating layer according to an interlocking pattern;
c/ depositing, on the electrically insulating layer, a layer forming a current collector of an electrode of opposite polarity to the one having the current collector formed by the metal element, the current collector layer being deposited on the interlocking pattern of the electrically insulating layer;
d/ depositing, on the metal element, a layer of electrode active material according to a pattern at least partly interlocked in the interlocking pattern;
e/ depositing, on the current collector layer, a layer of electrode active material of opposite polarity to the one deposited on the metal element, according to the interlocking pattern;
f/ depositing an electrolyte layer at least in the spaces separating the two layers of active material of mutually opposite polarity.

14. The process according to claim 13, step a/ being carried out by stamping a metal foil on an electronically insulating substrate.

15. The process according to claim 13, the deposition steps b/ to f/ being carried out by a printing technique.

16. A portable electronic device comprising:
a casing, and
the accumulator according to claim 1 for electrically powering the portable electronic device,
wherein the accumulator is integrated into said casing.
